(19) United States
(12) Patent Application Publication
(10) Pub. No.: US 2026/0056730 A1
(43) Pub. Date: Feb. 26, 2026

(54) ELECTRONIC DEVICE, FIRMWARE UPDATE METHOD, AND NON-TRANSITORY COMPUTER READABLE MEDIUM

(71) Applicant: Roland Corporation, Shizuoka (JP)

(72) Inventors: Marori Yoshioka, Shizuoka (JP); Ryo TAKASAKI, Hamamatsu (JP)

(73) Assignee: Roland Corporation, Shizuoka (JP)

(21) Appl. No.: 19/283,223

(22) Filed: Jul. 28, 2025

(30) Foreign Application Priority Data
Aug. 20, 2024 (JP) 2024-139258

(51) Int. Cl. G06F 8/65; G10H 1/00

(52) U.S. Cl. CPC G06F 8/65; G10H 1/0008; G10H 2240/161

(57) ABSTRACT

When an electronic musical instrument is attached to an external input/output device 13 of the sound source device 1, model information and a firmware version are received from the target electronic musical instrument, and the received version is compared with an incompatible version in a firmware table 11b. When the acquired version is an incompatible version or below, update data of the target electronic musical instrument in the firmware table 11b is acquired and transmitted to the target electronic musical instrument together with an instruction to update using the update data.

### CROSS-REFERENCE TO RELATED APPLICATION

This application claims the priority benefit of Japan application serial No. 2024-139258, filed on Aug. 20, 2024. The entirety of the above-mentioned patent application is hereby incorporated by reference herein and made a part of this specification.

### BACKGROUND

### Technical Field

The disclosure relates to an electronic device, a firmware update method, and a firmware update program.

### Description of Related Art

In an electronic musical instrument such as an electronic drum connected to a sound source device, firmware is installed. Conventionally, for example, as shown in Non-Patent Document 1, a personal computer (PC) is connected to an electronic percussion instrument, and the firmware of the electronic musical instrument is updated from an application on the PC.

### PRIOR ART DOCUMENT(S)

### Non-patent Document(s)

[Non-patent Document 1] Update-dedicated simple SMF player UpdSMF, [online], [searched on Aug. 19, 2024], Internet <URL: https://www.roland.com/jp/support/by_product/tm-1/updates_drivers/47e64fda-6e5f-483d-a95e-efbe369b3031/>

However, in the case of updating an electronic musical instrument from a PC, it is necessary to obtain firmware compatible with the electronic musical instrument and specify the firmware in the application. Therefore, user operations required for firmware update are complicated.

The disclosure provides an electronic device, a firmware update method, and a non-transitory computer-readable medium, recording a firmware update program that can reduce the user's efforts required to update the firmware of the electronic musical instrument.

### SUMMARY

An electronic device of the disclosure is an electronic device to which an electronic musical instrument is connected. The electronic device includes: a hardware processor configured to function as: a confirmation unit, configured to confirm whether firmware of the electronic musical instrument is compatible with the electronic device in a case where a connection of the electronic musical instrument is confirmed; a transmission unit, configured to transmit firmware compatible with the electronic device to the electronic musical instrument in a case where the confirmation unit has confirmed that the firmware of the electronic musical instrument is not compatible with the electronic device; and an instruction unit, configured to transmit, to the electronic musical instrument, an instruction of updating to the firmware transmitted by the transmission unit.

A firmware update method of the disclosure is executed by an electronic device to which an electronic musical instrument is connected. The firmware update method includes: a confirmation step of confirming whether firmware of the electronic musical instrument is compatible with the electronic device in a case where a connection of the electronic musical instrument is confirmed; a transmission step of transmitting firmware compatible with the electronic device to the electronic musical instrument in a case where the confirmation step has confirmed that the firmware of the electronic musical instrument is not compatible with the electronic device; and an instruction step of transmitting, to the electronic musical instrument, an instruction of updating to the firmware transmitted in the transmission step.

Also, a non-transitory computer readable medium of the disclosure stores a firmware update program. The firmware update program causes a computer connected with an electronic musical instrument to execute a firmware update process of the electronic musical instrument. The firmware update program causes the computer to execute: a confirmation step of confirming whether firmware of the electronic musical instrument is compatible in a case where a connection of the electronic musical instrument is confirmed; a transmission step of transmitting compatible firmware to the electronic musical instrument in a case where the confirmation step has confirmed that the firmware of the electronic musical instrument is not compatible; and an instruction step of transmitting, to the electronic musical instrument, an instruction of updating to the firmware transmitted in the transmission step.

### BRIEF DESCRIPTION OF THE DRAWINGS

FIG. 1 is a view showing the appearance of a sound source device.

FIG. 2A is a block diagram showing an electrical configuration of the sound source device, and

FIG. 2B is a diagram schematically showing a firmware table.

FIG. 3 is a block diagram showing an electrical configuration of an electronic drum.

FIG. 4 is a functional block diagram of a sound source device.

FIG. 5 is a flowchart of an attach process.

FIG. 6 is a flowchart of an update process.

FIG. 7 is a flowchart of a percussion process.

### DESCRIPTION OF THE EMBODIMENTS

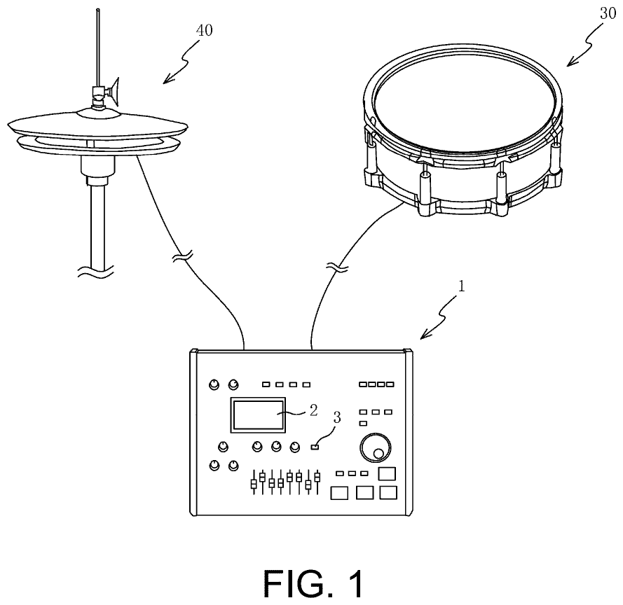

Hereinafter, exemplary embodiments will be described with reference to the accompanying drawings With reference to FIG. 1, an overview of a sound source device 1 of the embodiment will be described. FIG. 1 is a view showing the appearance of the sound source device 1. The sound source device 1 is an electronic device that outputs (emits) musical tones based on the performance information received from an electronic musical instrument such as an electronic drum 30. The sound source device 1 is provided with an LCD 2 on which various setting values, etc., are displayed, and a setting key 3 through which an instruction from a user H is input.

The electronic drum 30 and an electronic cymbal 40 are connected to the sound source device 1. The electronic drum 30 is an electronic percussion instrument (electronic musical instrument) that transmits the performance information corresponding to a strike on a striking surface by the user H to the sound source device 1, and the electronic cymbal 40 is an electronic percussion instrument (electronic musical instrument) that transmits the performance information corresponding to a strike on the striking surface by the user H to the sound source device 1. In the embodiment, an electronic hi-hat that imitates a hi-hat is used as the electronic cymbal 40, but the disclosure is not limited thereto, and an electronic cymbal that imitates other cymbals such as a ride cymbal may be used as the electronic cymbal 40.

The firmware is stored in each of the electronic drum 30 and the electronic cymbal 40, and various processes, such as creation of performance information at the time when the instrument is struck and transmission of the created performance information to the sound source device 1, are performed by the firmware. Since the electronic drum 30 or the electronic cymbal 40 connected to the sound source device 1 operates in cooperation with the sound source device 1, in the case where firmware not compatible with the sound source device 1 is stored in the electronic drum 30 or the electronic cymbal 40, performance information that cannot be analyzed by the sound source device 1 may be generated from the electronic drum 30 or the electronic cymbal 40 and transmitted to the sound source device 1, and there is a possibility that the sound source device 1 may malfunction due to the performance information.

Therefore, in the embodiment, in the case where the electronic drum 30 or the electronic cymbal 40 is connected to the sound source device 1 and the firmware of the electronic drum 30 or the electronic cymbal 40 is not compatible with the sound source device 1, the firmware of the electronic drum 30 or the electronic cymbal 40 is updated to the one compatible with the sound source device 1, thereby reducing the user H's efforts required for updating the software.

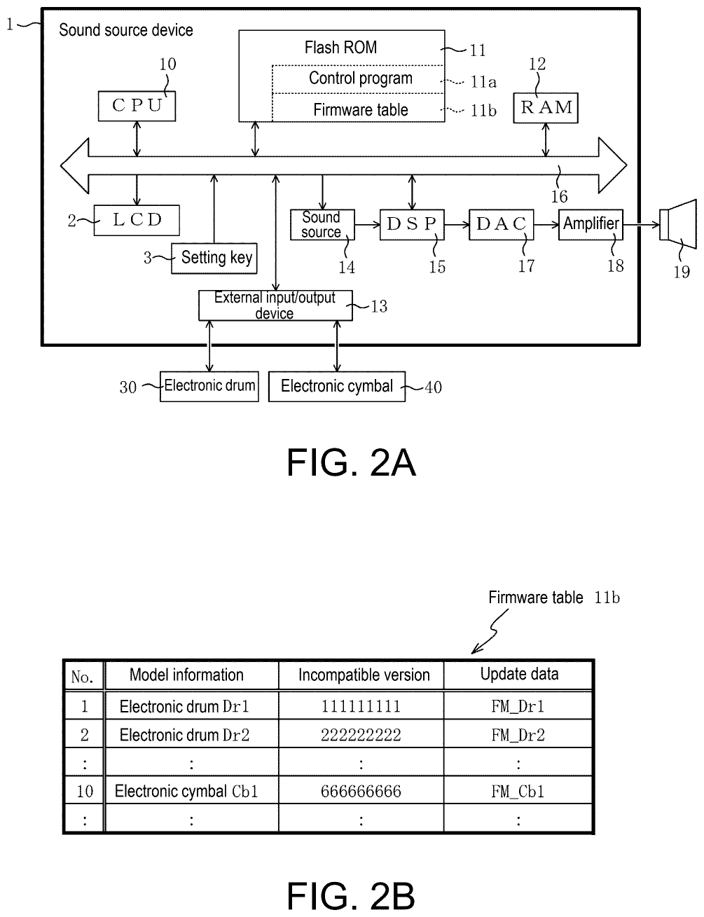

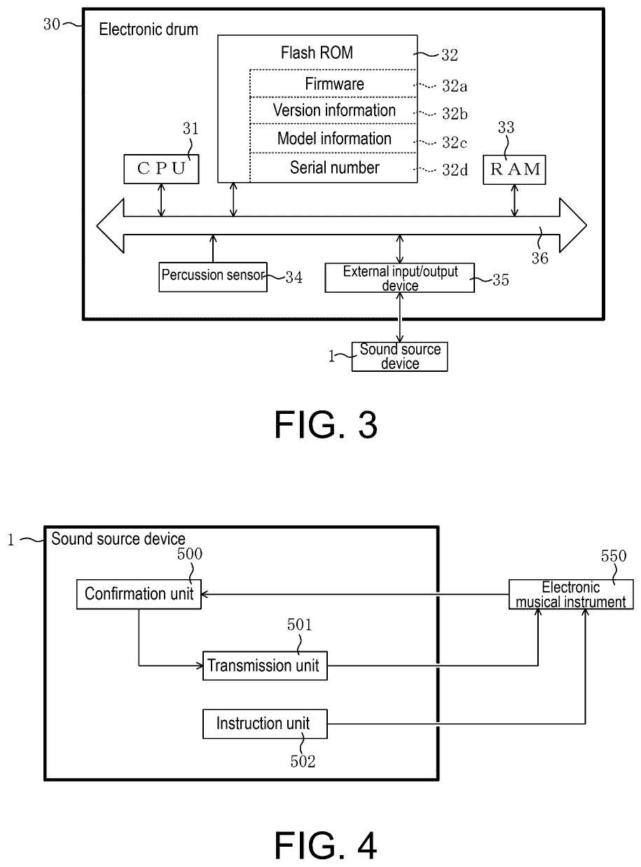

Next, with reference to FIGS. 2A and 2B and FIG. 3, the electrical configuration of the sound source device 1 and the electronic drum 30 will be described. Firstly, the electrical configuration of the sound source device 1 will be described with reference to FIGS. 2A and 2B. FIG. 2A is a block diagram showing the electrical configuration of the sound source device 1. The sound source device 1 includes a CPU 10, a flash ROM 11, a RAM 12, the LCD 2 and the setting key 3, an external input/output device 13, a sound source 14, and a digital signal processor (DSP) 15, which are respectively connected via a bus line 16. A digital analog converter (DAC) 17 is connected to the DSP 15, an amplifier 18 is connected to the DAC 17, and a speaker 19 is connected to the amplifier 18.

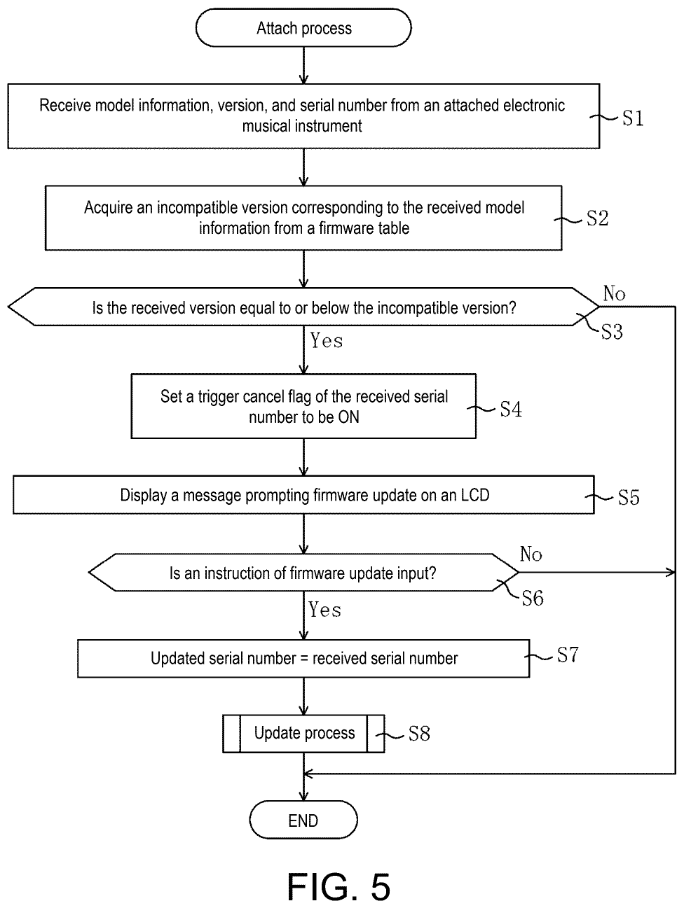

The CPU 10 is a computing device that controls each unit connected by the bus line 16. The flash ROM 11 is a rewritable non-volatile memory and includes a control program 11a and a firmware table 11b. When the control program 11a is executed by the CPU 10, an attach process of FIG. 5 is executed. The firmware table 11b will be described with reference to FIG. 2B.

FIG. 2B is a diagram schematically showing the firmware table 11b. In the firmware table 11b, model information, incompatible version, and update data are stored for each electronic musical instrument. The model information is information uniquely assigned to each model of the electronic musical instrument. The type of the target electronic musical instrument is identified based on such model information.

The incompatible version stores the version of the newest firmware among the firmware of the electronic musical instruments not compatible with the sound source device 1. In the embodiment, numbers assigned in ascending order are used as firmware versions, and the later the version, the newer the firmware. Since the incompatible version stores the version of the newest firmware that is not compatible with the sound source device 1, a firmware version equal to or below the incompatible version is considered as firmware not compatible with the sound source device 1.

The update data stores data in which the firmware compatible with the sound source device 1 in the electronic musical instrument and a command (referred to as “update command) for updating to the firmware for the electronic musical instrument. In the embodiment, the update data is configured by a standard MIDI file (SMF) that incorporates the firmware and the update command.

The version of the firmware is not limited to being expressed by using numbers assigned in an ascending order. For example, numbers assigned in a descending order may be used, or random numbers may be used. Also, the firmware version is not limited to using numbers; other types of characters such as alphabets or Chinese characters may be used, or a combination of numbers, alphabets, or Chinese characters may be used.

Also, the update data is not limited to being configured by using an SMF file, and may be data in other formats that incorporate firmware and update commands. Also, the update command may be stored in advance in the electronic musical instrument, and the update data may be only the firmware.

Returning to FIG. 2A, the RAM 12 is a memory that stores various work data, flags, etc., in a rewritable manner at the time when the CPU 10 executes a firmware update program such as the control program 11a. The external input/output device 13 is a device that inputs and outputs information from a connected external device. An electronic musical instrument such as the electronic drum 30 or the electronic cymbal 40 is connected to the external input/output device 13, and the firmware is transmitted from the sound source device 1 to the electronic musical instrument via the external input/output device 13, or the performance information from the electronic musical instrument is received by the sound source device 1.

In the embodiment, USB (registered trademark) is used as the communication standard of the external input/output device 13, but the external input/output device 13 may also be configured with other communication standards, or may be configured to input and output information from an external device through wireless communication.

The sound source 14 is a device that outputs waveform data according to the performance information input from the CPU 10. The DSP 15 is a computing device for performing an arithmetic process on the waveform data input from the sound source 14. The DAC 17 is a conversion device that converts the waveform data input from the DSP 15 into analog waveform data. The amplifier 18 is an amplification device that amplifies the analog waveform data output from the DAC 17 with a predetermined gain. The speaker 19 is an output device that emits (outputs) the analog waveform data amplified by the amplifier 18 as musical tones.

Next, the electrical configuration of the electronic drum 30 will be described with reference to FIG. 3. FIG. 3 is a block diagram showing the electrical configuration of the electronic drum 30. Here, the electrical configuration of the electronic drum 30 will be described, but since the electrical configurations of other electronic musical instruments such as the electronic cymbal 40 are similar, detailed descriptions of the electrical configurations will be omitted.

The electronic drum 30 includes a CPU 31, a flash ROM 32, a RAM 33, a percussion sensor 34 that detects a strike on a striking surface, and an external input/output device 35, each connected via a bus line 36. The CPU 31 is a computing device that controls each part connected by the bus line 36.

The flash ROM 32 is a rewritable non-volatile memory, and includes firmware 32a in which firmware for controlling each part of the electronic drum 30 is stored, version information 32b in which the version of the firmware is stored, model information 32c in which the model information of the electronic drum 30 is stored, and a serial number 32d. The serial number 32d stores a serial number that is individually assigned to each electronic musical instrument such as the electronic drum 30 and the electronic cymbal 40.

The RAM 33 is a memory that stores various work data and flags in a rewritable manner in the case where the CPU 31 executes a program such as firmware. The external input/output device 35 is a device that inputs and outputs information from a connected external device. In the embodiment, USB (registered trademark) similar to the external input/output device 13 of the sound source device 1 is used as the communication standard of the external input/output device 35, but other communication standards may be used as long as the standards are similar communication standards to the external input/output device 13.

Next, the functions of the sound source device 1 will be described with reference to FIG. 4. FIG. 4 is a functional block diagram of the sound source device 1. As shown in FIG. 4, the sound source device 1 includes a confirmation unit 500, a transmission unit 501, and an instruction unit 502.

The confirmation unit 500 is a unit that confirms whether the firmware of the electronic musical instrument 550 is compatible with the sound source device 1 in the case where the connection of an electronic musical instrument 550 such as the electronic drum 30 or the electronic cymbal 40 is confirmed, and the confirmation unit 500 is realized by the CPU 10 and the external input/output device 13. The transmission unit 501 is a unit that transmits the firmware compatible with the sound source device 1 to the electronic musical instrument 550 in the case where the confirmation unit 500 has confirmed that the firmware of the electronic musical instrument 550 is not compatible with the sound source device 1, and is realized by the CPU 10 and the external input/output device 13. In addition, the instruction unit 502 is a unit that transmits an instruction of updating to the firmware transmitted by the transmission unit 501 to the electronic musical instrument 550, and is realized by the CPU 10 and the external input/output device 13.

That is, in the sound source device 1 to which the electronic musical instrument 550 is connected, in the case where the connection of the electronic musical instrument 550 is confirmed, whether the firmware of the electronic musical instrument 550 is compatible with the sound source device 1 is confirmed, and in the case where the firmware of the electronic musical instrument 550 is not compatible with the sound source device 1, the firmware compatible with the sound source device 1 is transmitted to the electronic musical instrument 550, and the update to the firmware is instructed to the electronic musical instrument 550. Accordingly, the firmware of the electronic musical instrument 550 is updated to firmware compatible with the sound source device 1 simply by connecting the sound source device 1 to the electronic musical instrument 550. Thus, the efforts of the user H for updating the firmware of the electronic musical instrument 550 can be reduced.

Next, the processes executed by the CPU 10 of the sound source device 1 will be described with reference to FIG. 5 to FIG. 7. FIG. 5 is a flowchart of an attach process. The attach process is an event process executed in the case where an attach event of an electronic musical instrument issued when the electronic musical instrument, such as the electronic drum 30 or the electronic cymbal 40, is attached (connected) to the external input/output device 13 after the power of the sound source device 1 is turned on.

Firstly, the attach process receives model information, version, and serial number from the attached electronic musical instrument via the external input/output device 13 (S1). Specifically, an electronic musical instrument such as the electronic drum 30 attached to the sound source device 1 transmits the version, model information, and serial number stored in the version information 32b, the model information 32c, and the serial number 32d (see FIG. 3), respectively, to the sound source device 1 via the external input/output device 35. The sound source device 1 receives the model information, the version, and the serial number transmitted from the attached electronic musical instrument via the external input/output device 13.

After the process of S1, the incompatible version corresponding to the model information received in the process of S1 is acquired from the firmware table 11b (S2), and whether the version received in the process of S1 is the incompatible version acquired in the process of S2 or below is confirmed (S3).

In the process of S3, in the case where it is confirmed that the received version is the acquired incompatible version or below (S3: Yes), ON is set to the trigger cancel flag corresponding to the serial number received in the process of S1 (S4).

The trigger cancel flag is a flag provided for each serial number of the electronic musical instrument. In the case where the trigger cancel flag is set to OFF, if performance information is received from the electronic musical instrument of the serial number, a process according to the performance information (for example, sound generation of a musical tone based on the performance information) is performed. Meanwhile, in the case where the trigger cancel flag is set to ON, even if performance information is received from the electronic musical instrument of the serial number, the performance information is ignored and a process according to the performance information is not performed.

After the process of S4, a message prompting firmware update of the attached electronic musical instrument is displayed on the LCD 2 (S5). After the process of S5, whether an instruction to update the firmware of the electronic musical instrument attached from the user H is input via the setting key 3 is confirmed (S6).

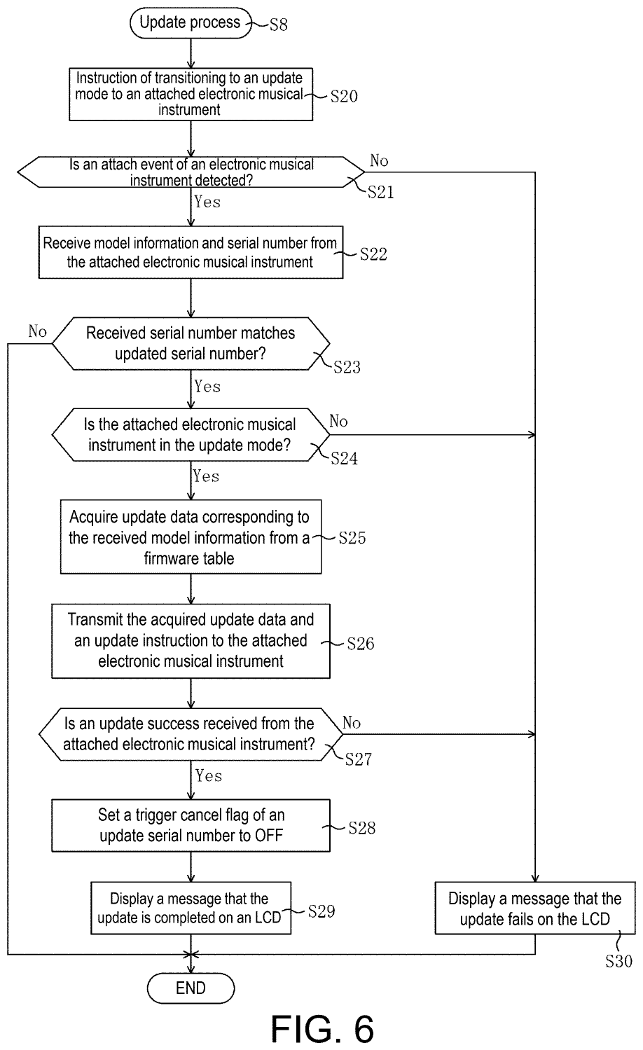

In the process of S6, in the case where it is confirmed that an instruction to update the firmware of the attached electronic musical instrument is input from the user H (S6: Yes), the serial number received in the process of S1 is set to the updated serial number. The updated serial number is a serial number of the electronic musical instrument that is the target for updating the firmware. After the process of S7, an update process (S8) described later in FIG. 6 is executed.

In the process of S3, in the case where it is confirmed that the received version is higher than the acquired incompatible version (S3: No), the processes of S4 to S8 are skipped. Also, in the process of S7, in the case where it is confirmed that an instruction to update the firmware of the attached electronic musical instrument is not input from the user H (S6: No), the processes of S7 and S8 are skipped. After the processes of S3, S6, and S8, the attach process is terminated.

Here, referring to FIG. 6, the update process of S8 is described. FIG. 6 is a flowchart of the update process. In the update process, firstly, the electronic musical instrument attached in the attach process of FIG. 5 is instructed to transition to an update mode (S20). The update mode is a mode for performing firmware update in the electronic musical instrument. The electronic musical instrument instructed to transition to the update mode restarts in the update mode and is attached to the sound source device 1 again.

After the process of S20, whether an attach event of the electronic musical instrument is detected is confirmed (S21). In the process of S21, in the case where it is confirmed that an attach event of the electronic musical instrument is detected (S21: Yes), the model information and the serial number are received from the attached electronic musical instrument via the external input/output device 13 (S22). In the embodiment, in the case where an attach event of the electronic musical instrument is detected in the process of S21, the attach process of FIG. 5 is configured to be note executed repeatedly.

After the process of S22, whether the serial number received in the process of S22 matches the updated serial number set in the process of S7 of FIG. 5 (S23) is confirmed. In the process of S23, in the case where it is confirmed that the received serial number matches the updated serial number (S23: Yes), whether the electronic musical instrument attached again in the process of S21 is in the update mode is confirmed (S24).

In the process of S24, in the case where it is confirmed that the electronic musical instrument that is attached again is in the update mode (S24: Yes), the update data corresponding to the model information received in the process of S22 is acquired from the firmware table 11b (S25), and the acquired update data and an instruction to update the firmware by using the update data are transmitted to the electronic musical instrument attached again in the process of S21 via the external input/output device 13 (S26).

The electronic musical instrument that receives the update data and the instruction to update updates its own firmware to the firmware included in the received update data according to the update command included in the update data. In the case where the firmware is updated successfully, the electronic musical instrument transmits an update success indicating such to the sound source device 1, and in the case where the firmware update fails, the electronic musical instrument transmits an update failure indicating such to the sound source device 1.

After the process of S26, whether the update success is received from the electronic musical instrument attached again in the process of S21 is confirmed (S27). In the process of S27, in the case where the update success is received from the electronic musical instrument attached again (S27: Yes), OFF is set to the trigger cancel flag of the updated serial number (i.e., the serial number of the electronic musical instrument attached again) (S28). After the process of S28, a message indicating that the firmware update is successful is displayed on the LCD 2 (S29).

In the process of S21, in the case where the detection of an attach event of the electronic musical instrument is not confirmed (S21: No), if it is confirmed that the electronic musical instrument attached again is not in the update mode in the process of S24 (S24: No), or if an update failure from the electronic musical instrument attached again is received in the process of S27 (S27: No), a message indicating that the firmware update fails is displayed on the LCD 2 (S30).

In the process of S23, in the case where it is confirmed that the received serial number does not match the updated serial number (S23: No), the processes of S24 to S30 are skipped. After the processes of S23, S29, and S30, the update process is terminated and the flow returns to the attach process of FIG. 5.

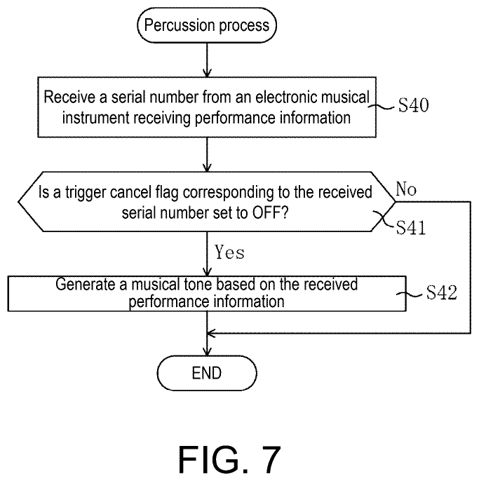

Next, the percussion process is described with reference to FIG. 7. FIG. 7 is a flowchart of the percussion process. The percussion process is an event process executed in the case where performance information is received from an electronic musical instrument via the external input/output device 13 after the power of the sound source device 1 is turned on, and is a process for generating a musical tone based on the received performance information.

The percussion process firstly receives a serial number from the electronic musical instrument that receives the performance information (S40). After the process of S40, whether the trigger cancel flag corresponding to the received serial number is OFF is confirmed (S41).

In the process of S41, in the case where it is confirmed that the trigger cancel flag corresponding to the received serial number is OFF (S41: Yes), a musical tone based on the received performance information is generated, and the generated musical tone is output (S42).

On the other hand, in the case where it is confirmed that the trigger cancel flag corresponding to the received serial number is ON in the process of S41 (S41: No), the process of S42 is skipped. As a result, the performance information which is received from an electronic musical instrument whose firmware is not compatible with the sound source device 1 and whose trigger cancel flag is ON is ignored, and the generation and output of the musical tone based on the performance information is not performed. In addition to generation and output of the musical tone, a process using the performance information which is received from the electronic musical instrument and whose trigger cancel flag ON is ignored.

After the processes of S41 and S42, the percussion process is terminated.

As described above, in the embodiment, in the case where an electronic musical instrument is attached to the external input/output device 13 of the sound source device 1, model information and firmware version are received from the target electronic musical instrument, and the received version is compared with the incompatible version corresponding to the acquired model information in the firmware table 11b.

In the case where the received version is equal to or below the incompatible version, that is, in the case where the firmware stored in the target electronic musical instrument is determined as not compatible with the sound source device 1 (FIG. 5, S3: Yes), the update data of the target electronic musical instrument in the firmware table 11b is acquired and transmitted to the target electronic musical instrument together with the instruction to perform update using the update data (S4 to S8). In the target electronic musical instrument, the firmware is updated to the firmware in the update data transmitted from the sound source device 1 according to the update command in the update data.

That is, simply by the user connecting the sound source device 1 to the target electronic musical instrument, the firmware of the target electronic musical instrument is updated to firmware compatible with the sound source device 1. As a result, for example, since the user H does not need to acquire the firmware for the target electronic musical instrument and update the firmware of the target electronic musical instrument by operating a PC application, etc., the efforts of the user H required for updating the firmware of the target electronic musical instrument can be reduced.

Also, in the case where the received version is equal to or below the incompatible version, the trigger cancel flag corresponding to the serial number of the target electronic musical instrument is set to ON (FIG. 5, S4), and the performance information is ignored (FIG. 7, S41), such as that a musical tone according to the performance information received from the target electronic musical instrument is not generated, until the trigger cancel flag is set to OFF, that is, until the firmware of the target electronic musical instrument is updated to the firmware that is compatible with the sound source device 1 (FIG. 6, S28). As a result, the situation in which the sound source device 1 malfunctions due to incorrect performance information received from an electronic musical instrument whose firmware is not compatible with the sound source device 1 can be suppressed.

Furthermore, in the case where the received version is higher than the incompatible version and it is determined that the firmware stored in the target electronic musical instrument is compatible with the sound source device 1 (FIG. 5, S3: No), the firmware update of the target electronic musical instrument according to the sound source device 1 is omitted. That is, in an electronic musical instrument in which firmware compatible with the sound source device 1 is stored, firmware update is omitted, and the period during which the user cannot use the electronic musical instrument due to unnecessary firmware update can be omitted. Therefore, the usability of the electronic musical instrument by the user H can be prevented from deteriorating.

The above description has been based on the above embodiment, but it can be easily inferred that various improvements and modifications are possible.

In the above embodiment, in the case where the version of the attached electronic musical instrument is equal to or below the incompatible version, the firmware of the electronic musical instrument is updated by using the update data stored in the firmware table 11b, but the disclosure is not limited thereto. For example, regardless of the version of the attached electronic musical instrument, the firmware of the attached electronic musical instrument may always be updated by using the update data stored in the firmware table 11b.

In the above embodiment, the performance information received from an electronic musical instrument whose trigger cancel flag set to ON is ignored, and musical tone generation based on the performance information is not performed. However, the disclosure is not limited thereto.

For example, musical tone generation based on the performance information received from the electronic musical instrument may be performed regardless of the state of the trigger cancel flag.

In the above embodiment, the electronic drum 30 or the electronic cymbal 40 is connected to the sound source device 1 as an electronic percussion instrument, but the disclosure is not limited thereto. For example, other electronic musical instruments such as an electronic tambourine or an electronic shaker may be connected to the sound source device 1, and the firmware of the instruments may be configured to be able to update the firmware from the sound source device 1.

Also, in the above embodiment, the electronic device is the sound source device 1, but the disclosure is not limited thereto. For example, the electronic device may be an electronic piano to which a damper pedal is connected, and may be configured so that the firmware of the damper pedal can be updated from the electronic piano. Also, the electronic device may be a wireless transmitter of an electric guitar to which a wireless headphone is connected, and may be configured so that the firmware of the wireless headphones can be updated from the wireless transmitter.

In the above embodiment, the update data including firmware compatible with the electronic musical instrument is stored in the firmware table 11b, but the disclosure is not limited thereto. For example, the update data may be stored in a server on the Internet, and in the case where the firmware of the electronic musical instrument is not compatible with the sound source device 1, update data including the compatible firmware may be received from the server.

In the above embodiment, the control program 11a is stored in the flash ROM 11 of the sound source device 1 and configured to operate on the sound source device 1. However, the disclosure is not necessarily limited thereto, and the control program 11a may be configured to operate on other computers such as a personal computer (PC), a mobile phone, smartphone, or a tablet terminal. In this case, a device similar to the external input/output device 13 may be provided in the PC, the mobile phone, etc., and configured to be connectable to an electronic musical instrument, such as the electronic drum 30.

What is claimed is:

1. An electronic device, to which an electronic musical instrument is connected, the electronic device comprising:
a hardware processor configured to function as:
a confirmation unit, configured to confirm whether firmware of the electronic musical instrument is compatible with the electronic device in a case where a connection of the electronic musical instrument is confirmed;
a transmission unit, configured to transmit firmware compatible with the electronic device to the electronic musical instrument in a case where the confirmation unit has confirmed that the firmware of the electronic musical instrument is not compatible with the electronic device; and
an instruction unit, configured to transmit, to the electronic musical instrument, an instruction of updating to the firmware transmitted by the transmission unit.

2. The electronic device according to claim 1, comprising:
a memory, configured to store firmware compatible with each connected electronic musical instrument,
wherein the transmission unit is configured to transmit the firmware in accordance with the connected electronic musical instrument, among the firmware stored in the memory, to the electronic musical instrument.

3. The electronic device according to claim 1, wherein the hardware processor is further configured to function as:
an update omission unit, configured to omit transmission of firmware by the transmission unit and transmission of an update instruction by the instruction unit in a case where the confirmation unit has confirmed that the firmware of the electronic musical instrument is compatible with the electronic device.

4. The electronic device according to claim 1, wherein the hardware processor is further configured to function as:
an ignore unit that ignores performance information received from the electronic musical instrument in a case where the confirmation unit has confirmed that the firmware of the electronic musical instrument is not compatible with the electronic device.

5. The electronic device according to claim 1, wherein the electronic device is configured by using an electronic musical instrument different from the electronic musical instrument that is connected.

6. The electronic device according to claim 1, wherein the hardware processor is further configured to function as:
an identification unit, configured to identify the electronic musical instrument that is a target for updating the firmware based on a serial number assigned to each electronic musical instrument,
wherein the transmission unit is configured to transmit the firmware compatible with the electronic device to the electronic musical instrument in a case where the confirmation unit has confirmed that the firmware of the electronic musical instrument is not compatible with the electronic device and the electronic musical instrument is identified as a target for updating firmware by using the identification unit.

7. The electronic device according to claim 2, wherein the hardware processor is further configured to function as:
an ignore unit that ignores performance information received from the electronic musical instrument in a case where the confirmation unit has confirmed that the firmware of the electronic musical instrument is not compatible with the electronic device.

8. The electronic device according to claim 3, wherein the hardware processor is further configured to function as:
an ignore unit that ignores performance information received from the electronic musical instrument in a case where the confirmation unit has confirmed that the firmware of the electronic musical instrument is not compatible with the electronic device.

9. A firmware update method, executed by an electronic device to which an electronic musical instrument is connected, the firmware update method comprising:
a confirmation step of confirming whether firmware of the electronic musical instrument is compatible with the electronic device in a case where a connection of the electronic musical instrument is confirmed;
a transmission step of transmitting firmware compatible with the electronic device to the electronic musical instrument in a case where the confirmation step has confirmed that the firmware of the electronic musical instrument is not compatible with the electronic device; and
an instruction step of transmitting, to the electronic musical instrument, an instruction of updating to the firmware transmitted in the transmission step.

10. The firmware update method according to claim 9, comprising
a storage step of storing firmware compatible with each connected electronic musical instrument,
wherein the transmission step transmits the firmware in accordance with the connected electronic musical instrument, among the firmware stored in the storage step, to the electronic musical instrument.

11. The firmware update method according to claim 9, comprising
an update omission step of omitting transmission of firmware by the transmission step and transmission of an update instruction by the instruction step in a case where the confirmation step has confirmed that the firmware of the electronic musical instrument is compatible with the electronic device.

12. The firmware update method according to claim 9, comprising
an ignore step of ignoring performance information received from the electronic musical instrument in a case where the confirmation step has confirmed that the firmware of the electronic musical instrument is not compatible with the electronic device.

13. The firmware update method according to claim 9, wherein the electronic device is configured by using an electronic musical instrument different from the electronic musical instrument that is connected.

14. The firmware update method according to claim 9, comprising
an identification step of identifying the electronic musical instrument that is a target for updating the firmware based on a serial number assigned to each electronic musical instrument,
wherein the transmission step transmits the firmware compatible with the electronic device to the electronic musical instrument in a case where the confirmation step has confirmed that the firmware of the electronic musical instrument is not compatible with the electronic device and the electronic musical instrument is identified as a target for updating firmware by using the identification step.

15. A non-transitory computer readable medium, storing a firmware update program, the firmware update program causing a computer connected with an electronic musical instrument to execute a firmware update process of the electronic musical instrument, wherein the firmware update program causes the computer to execute:
a confirmation step of confirming whether firmware of the electronic musical instrument is compatible in a case where a connection of the electronic musical instrument is confirmed;
a transmission step of transmitting compatible firmware to the electronic musical instrument in a case where the confirmation step has confirmed that the firmware of the electronic musical instrument is not compatible; and
an instruction step of transmitting, to the electronic musical instrument, an instruction of updating to the firmware transmitted in the transmission step.

16. The non-transitory computer readable medium according to claim 15, wherein the firmware update program causes the computer to execute:
a storage step of storing firmware compatible with each connected electronic musical instrument,
wherein the transmission step transmits the firmware in accordance with the connected electronic musical instrument, among the firmware stored in the storage step, to the electronic musical instrument.

17. The non-transitory computer readable medium according to claim 15, wherein the firmware update program causes the computer to execute:
an update omission step of omitting transmission of firmware by the transmission step and transmission of an update instruction by the instruction step in a case where the confirmation step has confirmed that the firmware of the electronic musical instrument is compatible with the electronic device.

18. The non-transitory computer readable medium according to claim 15, wherein the firmware update program causes the computer to execute:
an ignore step of ignoring performance information received from the electronic musical instrument in a case where the confirmation step has confirmed that the firmware of the electronic musical instrument is not compatible with the electronic device.

19. The non-transitory computer readable medium according to claim 15, wherein the electronic device is configured by using an electronic musical instrument different from the electronic musical instrument that is connected.

20. The non-transitory computer readable medium according to claim 15, wherein the firmware update program causes the computer to execute:
an identification step of identifying the electronic musical instrument that is a target for updating the firmware based on a serial number assigned to each electronic musical instrument,
wherein the transmission step transmits the firmware compatible with the electronic device to the electronic musical instrument in a case where the confirmation step has confirmed that the firmware of the electronic musical instrument is not compatible with the electronic device and the electronic musical instrument is identified as a target for updating firmware by using the identification step.
